(19) United States
(12) Patent Application Publication
(10) Pub. No.: US 2002/0164807 A1
(43) Pub. Date: Nov. 7, 2002

(54) Diagnostic instrument having overlapping carousels

(76) Inventors: Hideki Itaya, Cupertino, CA (US); Jason Dominik Hool, Pacific Palisades, CA (US); Javier Urena, San Jose, CA (US); Fredrick Spears, San Jose, CA (US); Osamu Ohno, Mountain View, CA (US); Kantaro Maruoka, Cupertino, CA (US)

Correspondence Address: Douglas A. Chaikin, Esq., PENINSULA IP GROUP, 2290 North First Street, Suite 101, San Jose, CA, 95131, US

(21) Appl. No.: 09/849,857

(22) Filed: May 3, 2001

(51) Int. Cl. G01N 35/00

(52) U.S. Cl. 436/45; 436/48; 436/49; 422/64; 422/65

(57) ABSTRACT

Disclosed herein is a diagnostic instrument for analyzing liquid samples. The diagnostic instrument in accordance with this invention includes a sample carousel and a diagnostic carousel. The sample carousel includes at least one sample tube and in the exemplary embodiment a plurality of sample tubes, each having unique identifying indicia readable by a machine reader. The sample tube capable of storing the liquid sample to be analyzed. The diagnostic carousel including at least one pipette capable of storing liquid sample to be analyzed. There are matching number of pipettes to sample tubes and each having matching unique identifying indicia which is matched with the appropriate sample tube. The diagnostic carousel being offset from the sample carousel and lying in a different plane from the sample carousel. Each pipette including a transfer mechanism for transferring sample from the sample tube directly to the pipette. The diagnostic instrument further including structure for bringing the pipette into contact with the sample tube, upon contact, the transfer mechanism of the pipette being activated for transferring sample from the sample tube to the pipette.

### RELATED CASE INFORMATION

This case is related to U.S. Patent Applications, “A Diagnostic Pipefte Assembly Including Apparatus For Automated Aspiration”, Hool et al, DOCKET NO HCDI1786 and “A Diagnostic Sample Tube Including Anti-Rotation Apparatus”, Hool et al, HCDI1787, filed concurrently and simultaneously with this application and for which, at this time no serial number or filing date exist.

### BACKGROUND OF THE INVENTION

### Field of the Invention

This invention relates generally to medical instruments and methods used in diagnostic analysis of biological liquid specimens and more particularly, to instruments and methods for automated multiple simultaneous diagnostic analysis using assays for such testing and even more particularly to such instruments which have at least one sample carousel and a diagnostic carousel and a structure for transfer of the liquid specimen from the sample carousel to the diagnostic carousel.

The testing of liquid biological samples has been ongoing for many years. As time passes, it becomes increasingly important to obtain faster and more accurate results using greater economical measures. There are many patent disclosures and other public documents that discuss various aspects of automating such procedures. The recent patent to Miyake et al, U.S. Pat. No. 6,197,255 B1 discloses an example of side-by-side carousels which includes a liquid delivery device for removing the sample from one of the side-by-side carousels and transferring it to the other side-by-side carousel. The patent to Sasaki et al, U.S. Pat. No. 6,193,933 also discloses similar side-by-side carousels in an automatic analysis apparatus. Similar side-by-side carousels are disclosed in Mitsumaki et al, U.S. Pat. No. 5,320,966 and Wakatake, U.S. Pat. No. 5,183,638. All of these devices are characterized by side-by-side carousels and a transfer device which moves the sample from one carousel to the other.

Others have disclosed rotating platforms that are offset, such as Minekane, U.S Pat. No. 4,906,433. Here, side-by-side carousels are combined with an offset platform for liquid analysis. The offset platform contains reagents and transfers from one carousel to the offset platform through a third mechanism or transfer mechanism. A similar mechanism is used by Berglund, U.S. Pat. No. 4,459,265.

However, none of these disclosures recognize that having to maneuver the liquid sample through a third mechanism, a transfer mechanism, poses serious risks and inefficiencies. For example, contamination of the entire carousel can result if the transfer mechanism is not keep perfectly clean. Thus, one must include a separate step for thoroughly cleansing the transfer mechanism as well as a separate structure on the instrument itself. Additionally, the risk of failure is always present. Should the cleansing mechanism fail even slightly the results in the entire carousel are in jeopardy, not simply one sample.

Clearly, the cleansing step requires time and additional equipment. This drives up the initial cost of the instrument. It also makes the diagnostic instrument less reliable since there is an increase in the risk of contamination as well as adding an additional function to the diagnostic instrument. The diagnostic instrument is also less economical to use. The additional equipment required by cleansing structure means that the instrument takes up more space. The greater the space taken up by the equipment, the greater the need for space. With the price of office rents and leases already extremely high in many areas, the cost of operating such a diagnostic instrument similarly increases. Thus, overall, the addition of the equipment necessary for cleansing makes the diagnostic equipment less useful when the true costs are fully appreciated.

What is needed is a diagnostic instrument capable of relatively trouble free automatic operation and which is cost effective. It would also be advantageous to have such a diagnostic instrument which is space efficient and minimizes the risk of contamination while increasing efficiency and economy of the overall operation.

### SUMMARY OF THE INVENTION

It is an object of this invention to provide a diagnostic instrument for analyzing liquid samples, which automates the diagnostic process and provides for direct transfer of the sample from the sample tube to the diagnostic vessel, in an exemplary embodiment a pipette.

It is an additional object of this invention to provide such a diagnostic instrument which includes a sample carousel and a diagnostic carousel which are offset and lie in different planes and to provide that those planes intersect defining a transfer zone for facilitating the direct transfer of sample from one carousel to the other.

It is an additional object of this invention to provide a diagnostic instrument which includes all of the above features and provides a small footprint for such an instrument.

The present invention is directed toward a diagnostic instrument which enables liquid sample to be transferred from a sample carousel to a diagnostic carousel for testing and analysis. The transfer is done directly and does not include the sample flowing through a third device or an intermediate apparatus. Rather, the diagnostic instrument includes a sample carousel including at least one sample tube having a pre-determined amount of sample, for example serum from human whole blood. The diagnostic instrument includes a second carousel having at least one corresponding and matching pipette. Each of the carousels rotates independently of one another. At the appropriate time, liquid, for example serum, is drawn from the sample tube to the pipette directly without going through a third device or apparatus such as a transfer mechanism.

In an exemplary embodiment of the diagnostic instrument in accordance with the invention, the sample carousel and the diagnostic carousel are offset from one another such that the sample carousel lies in a plane different than the diagnostic carousel. And, the planes have at least one zone of intersection, defining a transfer zone. The diagnostic instrument includes a device for lowering the pipette directly into the sample tube at the transfer zone. The diagnostic instrument includes a mechanism for drawing the liquid from the sample tube into the pipette, for example structure for creating a vacuum in the pipette to allow the liquid sample to be sucked into the pipette.

In accordance with the above objects and those that will be mentioned and will become apparent below, the diagnostic instrument in accordance with this invention comprises:

a rotatable first carousel having structure suitable for holding at least one sample, the sample being contained in a holder defining a sample tube, the sample tube being removably held by the first carousel, the first carousel being in a first plane;

a rotatable second carousel, the second carousel being independently rotatable from the first carousel, the second carousel overlapping the first carousel, the second carousel including a removable biological vessel for holding at least a portion of the sample, the biological vessel defining a pipette, the second carousel being in a second plane, different from the first plane, the first and second carousels overlapping and having a zone of intersection; and

a transfer mechanism for transferring at least a portion of the sample from the sample tube directly to the pipette at the zone of intersection, defining a transfer zone,

whereby, sample is capable of being transferred from the first carousel to the second carousel for diagnosis.

The diagnostic instrument includes, in an exemplary embodiment, a device for testing human blood serum. In this embodiment, each of the sample tube and the pipette has an outer surface and the outer surface has unique identifying indicia. The identifying indicia are machine readable, as for example a bar code reader. The instrument includes a bar code reader for each of the carousels. The instrument includes the ability to rotate the carousels so that matching unique identifying indicia are aligned. At the point of alignment, the transfer of sample is made directly from the sample tube to the pipette.

Another embodiment of the invention, comprises a method of accomplishing the invention in which the steps comprise:

inserting a sample contained in a sample tube into a first carousel, the sample tube having readable identifying indicia, the first carousel being rotatable and lying in a first plane;

rotating an overlapping second carousel including a pipette having readable identifying indicia for sample collection, the second carousel lying in a second plane, different from the first plane, such that the sample tube having matching identifying indicia with the pipette are aligned;

urging the pipette and sample tube together, the pipette including aspiration structure;

aspirating sample from the sample tube to the pipette; and rotating the second carousel for diagnosis.

It is an advantage of this invention to provide an offset pair of carousels to facilitate direct transfer of liquid sample from one of the carousels to the other.

It is another advantage of this invention to provide for direct transfer of sample liquid from one carousel to the other, such that no separate transfer mechanism is needed, eliminating the need for cleaning such a transfer mechanism and lessening the risk of contamination.

### BRIEF DESCRIPTION OF THE DRAWING

For a further understanding of the objects and advantages of the present invention, reference should be had to the following detailed description, taken in conjunction with the accompanying drawing, in which like parts are given like reference numerals and wherein:

FIG. 1 is a schematic three dimensional representation of a diagnostic instrument having overlapping carousels in accordance with the present invention.

FIG. 2 is a top plan view illustrating the rotational direction of the carousels in accordance with this invention.

FIGS. 3-6 are schematic representations, in three dimension view, of the procedural steps of transferring sample from the sample tube to the pipette in accordance with the present invention.

FIG. 7 is a top plan view of the diagnostic instrument in accordance with this invention illustrating the various testing stations used in an exemplary diagnostic procedure.

FIG. 8 is rear perspective view of an exemplary diagnostic instrument in accordance with this invention.

### DETAILED DESCRIPTION OF THE INVENTION

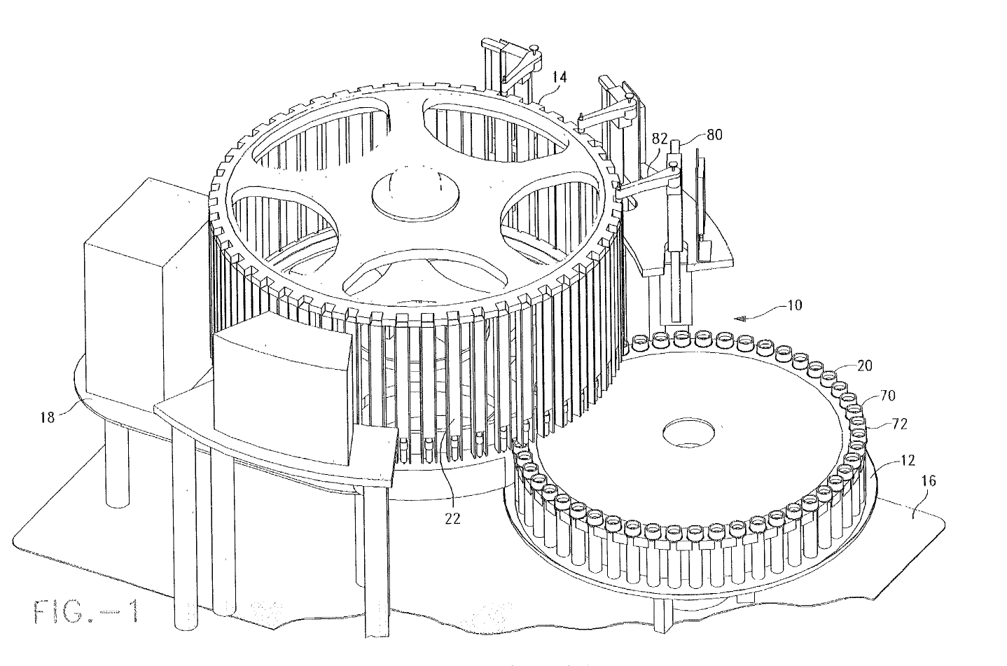

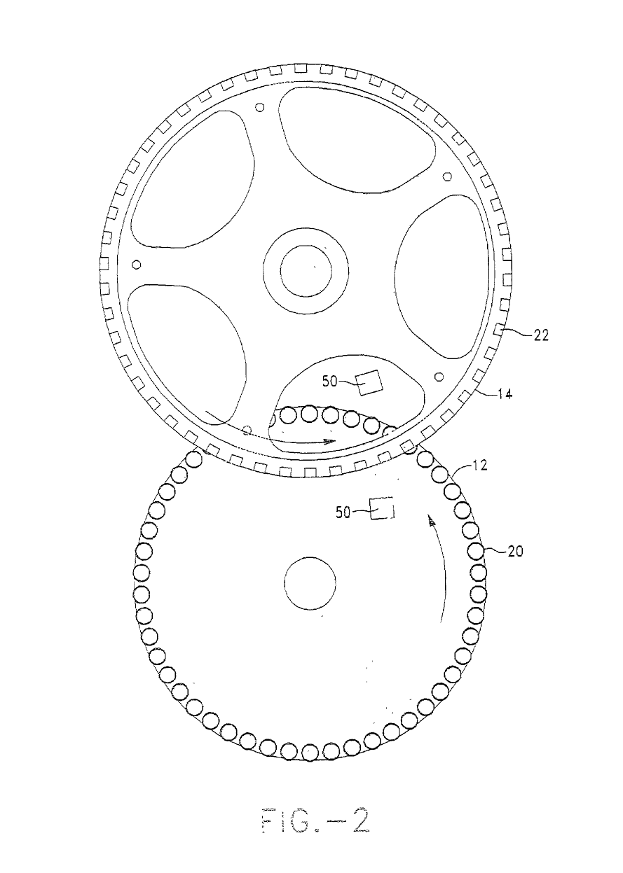

The invention will now be described with respect to the drawing and in particular to FIG. 1, which illustrates an exemplary embodiment of the invention, a diagnostic instrument, shown generally by the numeral 10. The diagnostic instrument 10 includes a first carousel 12 and a second carousel 14. The first carousel 12 is mounted on a platform 16 (shown partially in FIG. 1) and rotates in the direction shown in FIG. 2. The second carousel 14 is mounted on a second platform 18 and similarly rotates in the direction shown in FIG. 2. It will be appreciated that the carousels 12 and 14 may rotate in either direction, clockwise or counter-clockwise and either in the same direction or in opposed directions.

In the exemplary embodiment shown in FIG. 2 the carousels 12 and 14, respectively rotate independently and in the same direction, counter-clockwise. The carousel 12 rotates counter clockwise while the carousel 14 rotates in a clockwise direction. It has been found through experimentation that this facilitates the matching of the pipette with its sample tube.

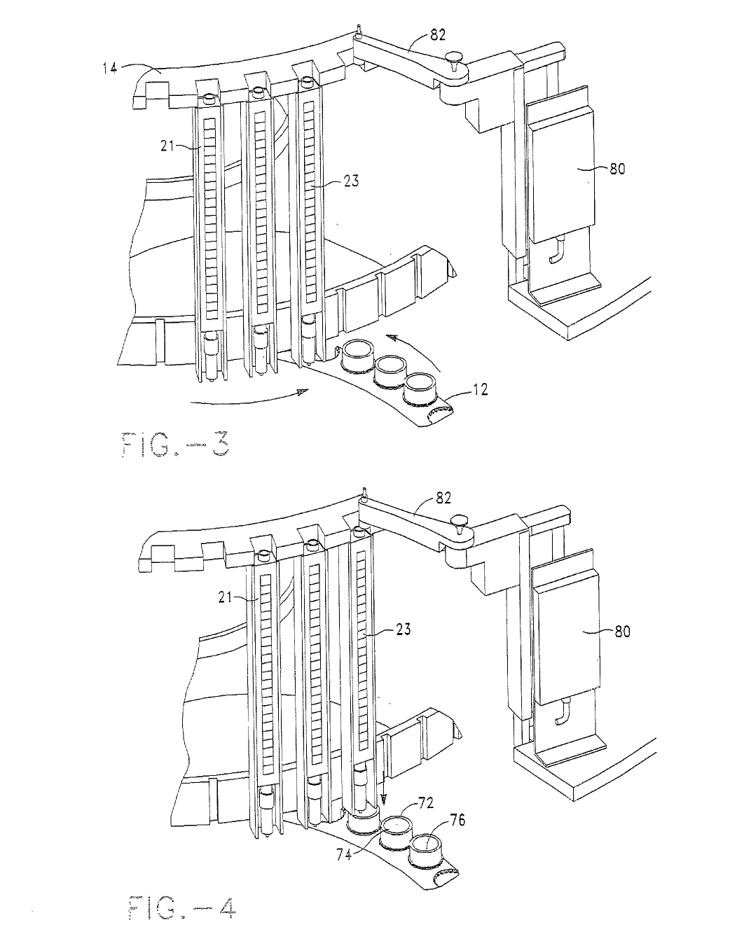

The first and second carousels, 12 and 14 respectively are found in different planes. In the exemplary embodiment shown in FIGS. 1 and 2, the second carousel 14 is elevated over the first carousel 12 because platform 18 is elevated as compared with platform 16. Additionally, the planes of the carousels 12 and 14, respectively, have at least one zone of intersection from the top view, such that the carousels 12 and 14 respectively define an overlapping architecture. As will be appreciated from the description below and with reference to FIGS. 3-6, this enables direct transfer of the sample from the sample tube into a pipette located on the second carousel 14. The point or area of intersection is defined as a transfer zone.

As shown in FIGS. 1 and 2, the carousel 12 has the ability to carry a plurality of sample tubes 20. In fact, the carousel 12 has a carrying capacity of 50 such sample tubes 20. It will be appreciated that larger or smaller carousels can be used within the spirit and scope of this invention and typically carousel capacity is in the range of between 30 and 120. The sample tubes 20 in an exemplary embodiment are approximately 170 mm in height and approximately 18 mm in diameter and are made from an engineering plastic. It will be appreciated that other materials and configurations are within the spirit and scope of the invention herein and for example, the sample tubes 20 could be made from glass.

The sample tube 20 is sized and shaped to compatibly and slidably connect with the first carousel 12. The first carousel 12, as does the second carousel 14, includes a plurality of slots for holding its respect sample tube 20 and pipette 22. As will be appreciated by those skilled in the art, various techniques are used to hold the sample tube 20 in place for identification. A commonly assigned patent application U.S. Patent Application (Docket No. HCDI1787) filed simultaneously with the instant patent application which is specifically incorporated herein by reference discloses anti-rotation device on the sample tube 20 in combination with the first carousel 12 for accomplishing the purposes of the instant invention.

In an exemplary embodiment, the diagnostic procedure to be performed by the diagnostic instrument 10 is an immunoassay to determine an individual's sensitivity to certain allergens. In this case, the sample comprises an individual's blood serum, which is loaded into the sample tube 20. The outer surface of the sample tube 20 has identifying indicia so that each individual's serum is unique to that person and only that person. No other sample or sample tube 20 would have matching identifying indicia. The indicia is in the form of bar code readable information such that a bar code reader 50 can easily identify a particular individual's sample tube as long as there has been little or no rotation of the sample tube 20.

The second carousel 14 has like capacity and carries a matching diagnostic vessel and in the exemplary embodiment is known as the pipette 22. Thus, for each sample tube 20 that is carried by the first carousel 12, a corresponding pipette 22 is carried by the second carousel 14. Each of the sample tube 20 and the pipette 22 has machine readable indicia on an outside surface. An optical reader for each of the carousels 12 and 14, respectively matches the tube 20 to the corresponding pipette 22 by rotating respective carousels to the transfer zone. The sample may then be extracted from the sample tube 20 directly into the pipette 22 as will be explained in detail with regard to FIGS. 3-6.

The pipette 22 has a compatible size and shape to be loaded into the second carousel 14 by sliding the pipette 22 into a slot on the second carousel 14. The pipette 22 includes a tip 24. The diagnostic instrument 10 includes a lowering mechanism 30 having an arm 32. At the appropriate time determined by other automated structure within the diagnostic instrument 10, the arm 32 attaches to the pipette 22 and lowers the pipette tip 24 into the sample tube 20. As will be explained in greater detail with reference to FIGS. 3-6, upon being lowered into the sample tube, the tip 24 opens the bottom of the pipette 22 and a vacuum mechanism (not shown) connected to the top of the pipette 22 is activated to draw liquid sample directly from the sample tube 20 into the pipette 22. A commonly assigned patent application filed concurrently and simultaneously, U.S. Patent Application (Docket No. HCDI1787), with the instant patent application, which is specifically incorporated herein by reference, discloses a novel tip structure and pipette apparatus for accomplishing the purposes of the instant invention.

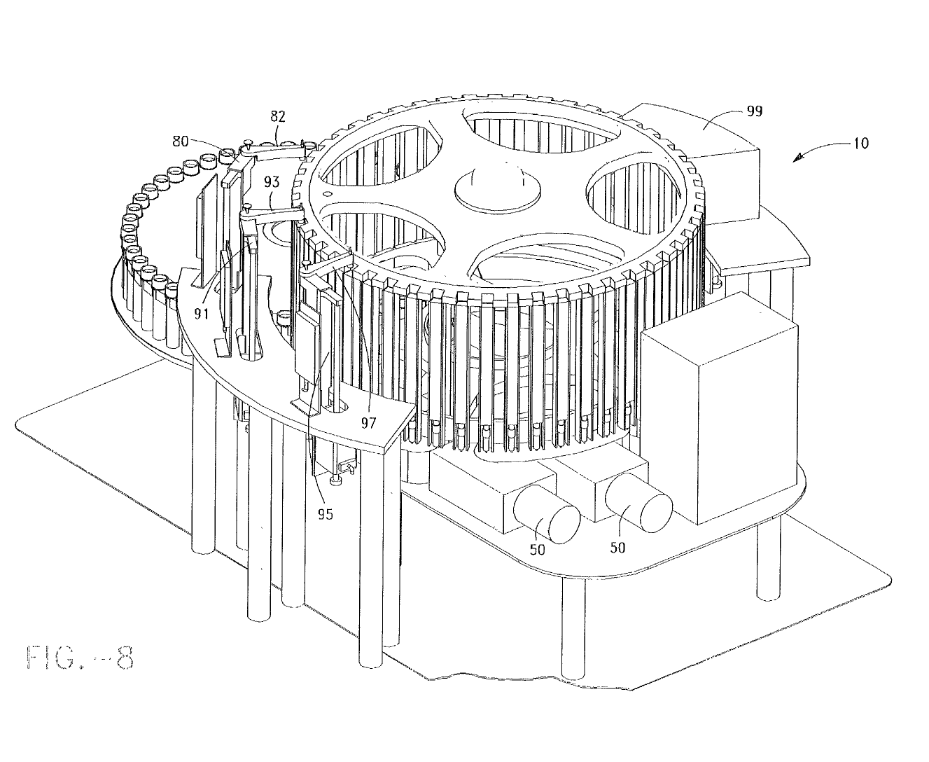

Since the pipette 22 is not round, nor is it typically found to be round in the art, and since it is slid lockably into the slot on the second carousel 14, there is not likely to be any rotational movement of the pipette 22 relative the second carousel 14. Therefore, a similar bar code reader 50 (FIG. 7) readily reads the unique identifying indicia on the outer surface of the pipette 22. Once the matching sample tube 20 and pipette 22 have been located, they are aligned and the pipette tip 24 lowered into the sample tube 20 as described in more detail with reference to FIGS. 3-6. As illustrated in FIGS. 3-6, the pette 22 is lowered into the sample tube 20 for aspiration of the sample into the pette 22. The sample tube 20 has a proximal end 70 (FIG. 1) and a distal end 72 (FIG. 1). As best seen in FIGS. 1, 3-6, the proximal end 70 defines an end zone comprising a sample cup 74. The sample cup 74 contains liquid sample 76 and in the exemplary embodiment blood serum.

The diagnostic instrument 10 includes, in the exemplary embodiment, the lowering mechanism 30 comprising an elevator 80 having an arm 82. The elevator 80 includes a vertically driven motor (not shown) which lowers and raises the pette 22.

As shown in FIG. 1 and as will be appreciated more fully with respect to the description of FIGS. 7 and 8, the diagnostic instrument 10 includes three such lowering mechanisms 30. Each such lowering mechanism 30 is mechanically identical, but each serves a distinct purpose. Universally, each elevator station is mechanically responsible for lowering and raising the elevation of the pipette 22 and is responsible for the flow of liquid into and out of the pipette 22.

The diagnostic instrument 10 additionally includes a liquid pump (not shown) having tubing (not shown) running from the liquid pump through the elevator 80 and to the elevator arm 82. The elevator arm 82 has a distal end 84 having a connection structure for connecting proximal end of the pette 22 for creating a vacuum or other sucking force for aspirating liquid from the sample cup 74 to the pette 22.

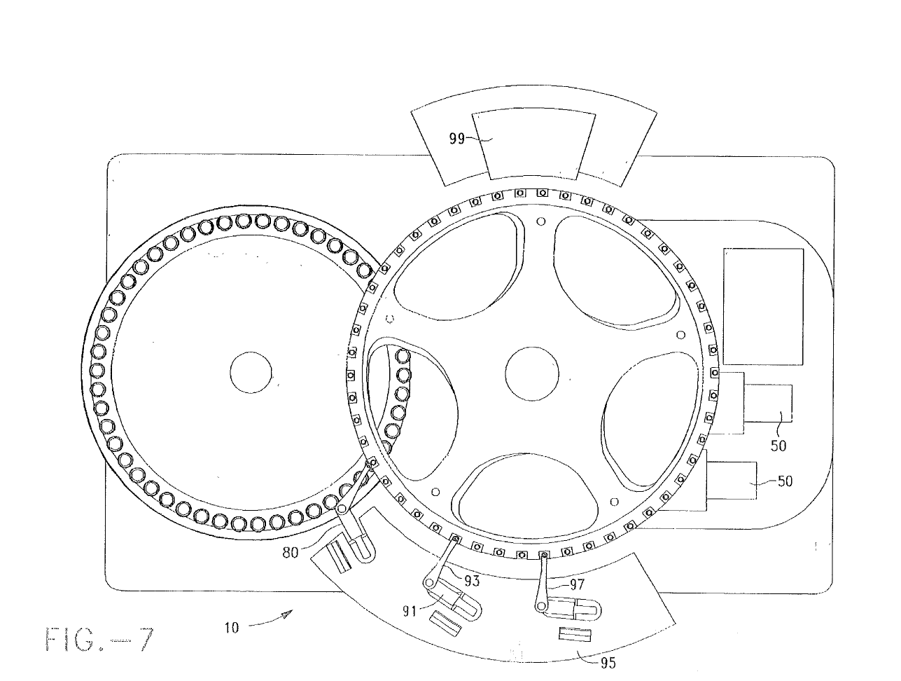

As shown in FIG. 6, at the appropriate time, determined by other automated structure within the diagnostic instrument 10, the arm 82 attaches to the proximal end of the pette 22 and lowers the pette tip 14 into the sample cup 74. As explained in greater detail in U.S. Patent No. (Attorney Docket No. HCDI1786 with reference to FIGS. 8-11), upon being lowered into the sample tube, the pette tip opens the bottom of the pette 22 and the liquid pump (not shown) connected to the pette is activated to draw liquid sample directly from the sample cup 72 into the pette 22.

As shown in FIG. 7, after aspiration, the pette 22 is raised closing the pette tip 14. The pette 22 is raised by the rotary elevator 80 to its original position on the diagnosis carousel 14 (FIG. 4). After raising the pette 22, various reagents are added and washed to obtain the diagnosis of the sample tested. There may be multiple rinsing stages, a waiting or incubation state and the addition of various reagents depending on the diagnosis being conducted. Once all of the steps are completed for diagnosis, typically the pette is rotated to the photographic station where a picture is taken to show and record the diagnosis results.

As will be appreciated from the drawing and especially FIG. 3, the outer surface of the pette 22 comprising cover 21 has a series of windows 23. In the immunoassay example of the exemplary embodiment of the invention, each of the windows 23 may represent a different allergen to which the patient may be allergic. Thus, in one testing procedure, a number of different antigens can be tested promoting efficiency and economy. In fact, in the preferred embodiment shown in FIG. 3, there are 36 different windows and up to 36 different antigens or groups of antigens may be tested.

With particular reference to FIGS. 3-6, there is shown the procedure and apparatus for aspirating the sample from the sample tube 20 directly into the pipette 22. Initially, sample is taken from a patient in the form of whole blood. The blood is put through a series of steps to extract the serum. The serum is loaded into the sample tube 20 and placed on the first carousel 14, also known as the sample carousel. As set forth above, the sample tube 20 has an outer surface with unique identifying indicia as set forth above. And that identifying indicia is in machine readable format, such as by the bar code reader 50, also as set forth above.

The first and second carousels, 12 and 14, respectively are rotated in the direction shown by the arrows until the sample tube 20 aligns with the matching pipette 22 as shown in FIG. 3. Once aligned, as shown particularly in FIG. 4, the pipette 22 is lowered into its corresponding sample tube 20 for aspiration of the sample directly into the pipette 22.

The pipette 22 is lowered by a rotary elevator which grabs the pipette 22 and lowers it into the sample tube 20. The pipette tip 24 is depressible and is sized and shaped to contact the bottom of the sample tube 20 depressing the tip and opening one end of the pipette 22 adjacent the tip and in this case defining the bottom of the pipette 22.

In an exemplary embodiment of the pipette 22, the tip 24 defines a valve for allowing fluid to flow only when the tip is pressed against a solid surface. In other words, a one way valve which in response to pressure allows fluid in and through the chambers, but prevents the entry of fluid into the tip 24 or from leaking through the bottom in the normal case.

A vacuum mechanism (not shown) is connected to the top of the pipette 22 and causes liquid sample from the sample to aspirate or be sucked into the pipette 22. Upon an appropriate command the vacuum is shut off and further fluid flow ceases.

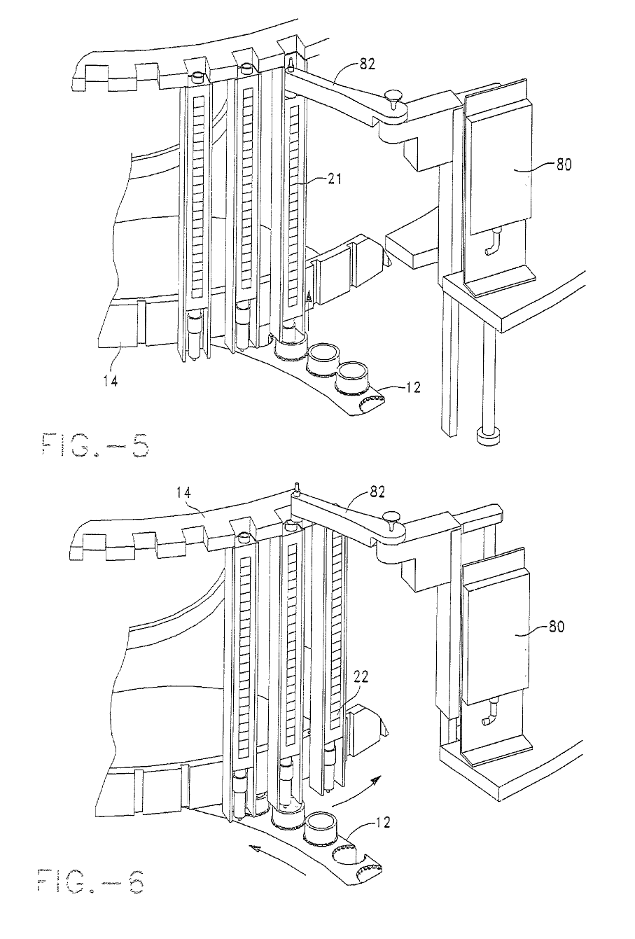

As shown in FIG. 5, after aspiration, the pipette 22 is raised closing the pipette tip 24 in the exemplary embodiment. The pipette 22 is raised by the rotary elevator to its original position on the diagnosis carousel 14. After raising the pipette 22, various reagents are added and washed to obtain the diagnosis of the sample tested. There may be multiple rinsing stages, a waiting or incubation state and the addition of various reagents depending on the diagnosis being conducted. Once all of the steps are completed for diagnosis, typically the pipette is rotated to the photographic station where a picture is taken to show and record the diagnosis results.

As will be appreciated from FIGS. 3-6, the outer surface of the pipette 22 has a series of windows 23. In the immunoassay example of the exemplary embodiment of the invention, each of the windows 23 may represent a different allergen to which the patient is allergic. Thus, in one testing procedure, a number of different antigens can be tested promoting efficiency and economy.

As shown in FIG. 6, the carousels 12 and 14 rotate independently for diagnosis and alignment of the next pipette 22 and sample tube 20. For example, as described above, should various rinses and washes as well as different reagents be necessary, the diagnosis carousel is merely rotated to the desired station for the appropriate procedure. Similarly, the sample carousel 12 is independently rotated or held in position awaiting testing of the next patient sample.

As will be appreciated from the above description, the sample tubes 20 and the pipettes 22 may be loaded randomly into their respective carousels 12 and 14. This is because each of the tubes 20 and pipettes 22 have outside identifying indicia and a bar code reader 50 identifies the indicia and finds the corresponding and matching pair, aligns the pair.

With particular reference to FIGS. 7 and 8, there is seen a top plan view of the diagnostic instrument 10, in accordance with this invention. The diagnostic instrument 10 includes bar codes readers 50 for aligning the first and second carousels 12 and 14, respectively as set forth above. Various procedures are performed on the sample as described below.

Upon aspiration, the pipette 22 is filled with the desired amount of serum for undergoing the particular series of procedures to determine patient diagnosis. In the case of an immunoassay, the rotary elevator raises the pipette 22 closing the pette tip as discussed in detail in U.S. Patent Application (HCDI1786) in the exemplary embodiment. The transfer takes place at the plane of intersection between the two carousels 12 and 14. The pipette 22 is raised back into the diagnostic carousel 14.

The diagnostic carousel 14 is rotated to a second lowering mechanism 30 defining a wash station 91 and having an arm 93. The arm 93 grabs the pipette 22 and lowers the pipette 22 into a wash basin (not shown). In the wash basin, the interior of the pipette 22 is washed. The pette tip opens allowing any previously stored fluid to be drained. Thus, in the exemplary case noted above, the pette tip is depressed by contact with the bottom of the wash basin opening and draining serum from the pette 22.

Once the pipette 22 is opened, a predetermined volume of wash buffer is pumped through the pipette 22. The wash flows through the pipette 22 from its top to its bottom. Once the interior of the pipette 22 has been flushed with wash buffer, the arm 93 raises the pipette 22 back into the diagnostic carousel 14.

As noted above, there are three lowering mechanisms 30. The third lowering mechanism 30 defines a reagent station 95. The reagent station 95 includes a similar arm mechanism designated by the numeral 97 as the previously described stations. The reagent station 95 includes a reagent delivery basin (not shown) lying directly below the arm 97. The reagent station 95 delivers various chemical reagents into the pipette 22. Firstly, the appropriate chemical reagent is deposited into the reagent delivery basin. Secondly, once the appropriate chemical reagent has been deposited into the reagent delivery basin, the designated pipette 22 is lowered into the reagent delivery basin by the arm 97. The pipette 22 is lowered such that the pipette tip is depressed against the bottom of the reagent delivery basin again opening the pipette tip. Thirdly, with the pipette tip open and submerged in chemical reagent, the aspiration pump (not shown) sucks, or aspirates, the chemical reagent out of the reagent delivery basin directly into the pipette 22. Finally, once the pipette 22 is full of chemical reagent the aspirator pump is switched off and the arm raises the pipette 22 back into the diagnostic carousel 14.

The pipette 22 with its sample of serum, for example, undergoes a series of procedures to determine patient diagnosis. In the case of the immunoassay, the serum is first aspirated into the pipette 22 at the serum aspiration station 80. After an incubation period, the pipette 22 is then drained of serum and flushed with a wash buffer at the wash station 91. Having been washed, the pipette 22 moves on to the reagent station 95, where an antibody conjugate is aspirated into the pipette 22. After a second incubation period, the pipette 22 is then drained of antibody conjugate and flushed with a wash buffer at the wash station 91. Having been washed a second time, the pipette 22 then rotates to the reagent station 95 for a second time, where a photo reagent is aspirated into the pipette 22. After a third incubation period, the pipette 22 is then moved to a photo-detector 99 where photographic analysis is made. Analysis of the photographic results is used to render a patient's diagnosis.

While the foregoing detailed description has described several embodiments of the methods and apparatus of the diagnostic instrument in accordance with this invention, it is to be understood that the above description is illustrative only and not limiting of the disclosed invention. Particularly, the carousels can rotate in either direction as long as there is an intersection suitable for transferring sample from the sample tube to its matching pipette. Additionally, the instrument could be used to automatically transfer different types of materials from one container to another in an efficient manner. It will be appreciated that the embodiments discussed above and the virtually infinite embodiments that are not mentioned could easily be within the scope and spirit of this invention. Thus, the invention is to be limited only by the claims as set forth below.

What is claimed is:

1. A diagnostic instrument for analyzing liquid samples, comprising;
a sample carousel including at least one sample tube, the sample tube capable of storing liquid sample to be analyzed;
a diagnostic carousel including at least one diagnostic vessel capable of storing liquid sample to be analyzed, the diagnostic carousel being offset from the sample carousel and lying in a different plane from the sample carousel, the diagnostic vessel including a transfer mechanism for transferring sample from the sample tube directly to the pipette; and
structure for bringing the diagnostic vessel into contact with the sample tube, upon contact the transfer mechanism of the pipette being activated for transferring sample from the sample tube to the diagnostic vessel.

2. The diagnostic instrument as set forth in claim 1, wherein the diagnostic vessel defines a pipette.

3. The diagnostic instrument as set forth in claim 1, wherein the diagnostic carousel lies in a plane that is elevated above the sample carousel plane.

4. The diagnostic instrument as set forth in claim 3, wherein the structure for bringing the pipette into contact with the sample tube includes an elevator structure having an arm capable of connecting with the pipette and lowering the pipette into the sample tube.

5. The diagnostic instrument as set forth in claim 4, wherein the elevator structure comprises a rotary elevator.

6. The diagnostic instrument as set forth in claim 1, wherein sample carousel has a capacity of between 30 and 120 sample tubes.

7. The diagnostic instrument as set forth in claim 6, wherein there are a plurality of sample tubes and a matching number of pipettes.

8. The diagnostic instrument as set forth in claim 7, wherein each of the sample tubes and pipettes have unique identifying indicia such that there is a matching pipette for every sample tube and the diagnostic instrument includes means for reading the unique identifying indicia and matching and aligning the appropriate sample tube and pipette together.

9. The diagnostic instrument as set forth in claim 1, wherein the sample tube has an open proximal end and the proximal end includes a sample cup for storing the sample.

10. An instrument for analyzing liquid samples, comprising;
a sample carousel including structure for storing a plurality of sample tubes, the sample tubes capable of containing the liquid sample to be tested;
a diagnostic carousel including structure for storing a plurality of pipettes, the diagnostic carousel being offset from the sample carousel, each of the pipettes including a transfer mechanism for transferring the sample from the sample tube directly to the pipette; and
structure for bringing the pipette into contact with the sample tube, upon contact the transfer mechanism of the pipette being activated for transferring sample from the sample tube to the pipette.

11. The instrument as set forth in claim 10, wherein the diagnostic carousel lies in a plane that is elevated above the sample carousel plane.

12. The instrument as set forth in claim 11, wherein the structure for bringing the pipette into contact with the sample tube includes an elevator structure having an arm capable of connecting with the pipette and lowering the pipette into the sample tube.

13. The instrument as set forth in claim 10, wherein each of the carousels is rotatable.

14. The instrument as set forth in claim 10, wherein each of the carousels is independently rotatable.

15. A instrument having overlapping carousel instrument, comprising:
a rotatable first carousel having structure suitable for holding at least one sample, the sample being contained in a holder defining a sample tube, the sample tube being removably held by the first carousel, the first carousel being in a first plane;
a rotatable second carousel, the second carousel being independently rotatable from the first carousel, the second carousel overlapping the first carousel, the second carousel including removable structure for holding at least a portion of the sample, the holding structure defining a pipette, the second carousel being in a second plane, different from the first plane, the first and second carousels overlapping and having zone of intersection; and
a transfer mechanism for transferring at least a portion of the sample from the sample tube directly to the pipette at the zone of intersection, defining a transfer zone,
whereby, sample is capable of being transferred from the first carousel to the second carousel for diagnosis.

16. The instrument as set forth in claim 15, wherein the sample tube and the pipette each have identifying indicia and wherein each of the carousel includes a reading structure for reading the indicia and wherein each carousel includes a mechanism for rotating it through the zone of intersection such that the sample tube and the pipette having matching indicia are aligned for transferring at least a portion of the sample from the sample tube to the pipette for diagnosis.

17. The instrument as set forth in claim 16, wherein the reading structure for each of the carousels comprises a bar code reader.

18. The instrument as set forth in claim 15, wherein the transfer mechanism comprises the pipette having an aspiration structure and being brought together with the sample tube to aspirate the sample from the sample tube to the pipette.

19. A method of testing a sample in a diagnostic instrument including overlapping carousels, the steps comprising:
inserting a sample contained in a sample tube into a first carousel, the sample tube having readable identifying indicia, the first carousel being rotatable and lying in a first plane;
rotating an overlapping second carousel including a pipette having readable identifying indicia for sample collection, the second carousel lying in a second plane, different from the first plane, such that the sample tube having matching identifying indicia with the pipette are aligned;
urging the pipette and sample tube together, the pipette including aspiration structure; 5
aspirating sample from the sample tube to the pipette; and

20. The method of testing a sample in a diagnostic instrument as set forth in claim 19 wherein, the steps further include:
after aspirating sample from the sample tube, raising the pipette and rotating it to a first station to begin the diagnostic process.

21. The method of testing a sample in a diagnostic instrument as set forth in claim 19 wherein, the steps further include:
the pipette having an outer surface and the outer surface has a plurality windows and each of the windows represents a different testing criteria and wherein the diagnostic procedure includes multiple simultaneous analysis and diagnosis of the sample.
